(19) United States
(12) Patent Application Publication
(10) Pub. No.: US 2026/0062249 A1
(43) Pub. Date: Mar. 5, 2026

(54) WIRE FEEDER

(71) Applicant: SAMSUNG ELECTRONICS CO., LTD., SUWON-SI (KR)

(72) Inventors: Doojin Kim, Suwon-si (KR); Byongjoo Kim, Suwon-si (KR); Youngsu Kang, Suwon-si (KR); Kwanhyub Nam, Suwon-si (KR); Hyunjin Lim, Suwon-si (KR)

(21) Appl. No.: 19/072,490

(22) Filed: Mar. 6, 2025

(30) Foreign Application Priority Data
Sep. 4, 2024 (KR) 10-2024-0119939

(51) Int. Cl. B65H 57/00; B23K 20/00; B23K 101/40; B65H 57/12; B65H 67/02; H01L 23/00

(52) U.S. Cl. CPC B65H 57/003; B23K 20/004; B65H 57/12; B23K 2101/40; B65H 67/02; B65H 2406/30; B65H 2553/412; B65H 2701/361

(57) ABSTRACT

A wire feeder includes a cartridge disposed in a supply position and having a wire spool wound with a wire, and including an outlet portion through which the wire is drawn outwardly along an internal travel path, an air guide disposed on a wire supply path and including a first inlet portion through which the wire drawn out from the outlet portion is drawn in, wherein the first inlet portion is aligned with the outlet portion on the wire supply path, a sensor disposed at the first inlet portion of the air guide, and a first vacuum line generating a vacuum in an interior of the first inlet portion according to a detection of the wire at the first inlet by the sensor.

### CROSS-REFERENCE TO RELATED APPLICATION(S)

This application claims priority under 35 USC 119 (a) to Korean Patent Application No. 10-2024-0119939, filed on Sep. 4, 2024, in the Korean Intellectual Property Office, the entire disclosure of which is herein incorporated by reference for all purposes.

### BACKGROUND

### 1. Technical Field

The present inventive concept relates to a wire feeder, and more particularly to a wire feeder including a vacuum line.

### 2. Discussion of Related Art

Semiconductor packages may be manufactured through processes including a wire bonding process, a cutting process, a die bonding process, a molding process, and a marking process. For example, the wire bonding process may be a process of connecting pads of a semiconductor chip and leads of a substrate with wires, or connecting respective pads of semiconductor chips with wires. To perform such a wire bonding, wires may be supplied from a wire spool to a capillary through a wire feeder, and bonding work may be performed using the capillary. In this bonding process, the wire spool should be replaced periodically. When replacing the wire spool, a worker uses a tool, such as tweezers, to manually pass the wire from the newly replaced wire spool through various components of the wire feeder and insert the wire into the capillary of the wire feeder.

### SUMMARY

Example embodiments provide a wire feeder in which efficient insertion of a wire may be implemented.

According to example embodiments, a wire feeder includes a cartridge disposed in a supply position and having a wire spool wound with a wire, and including an outlet portion through which the wire is drawn outwardly along an internal travel path; an air guide disposed on a wire supply path and including a first inlet portion through which the wire drawn out from the outlet portion is drawn in, wherein the first inlet portion is aligned with the outlet portion on the wire supply path; a sensor disposed at the first inlet portion of the air guide; and a first vacuum line generating a vacuum in an interior of the first inlet portion according to a detection of the wire at the first inlet portion by the sensor.

According to example embodiments, a wire feeder includes a main body including a mounting part configured to secure a cartridge in a supply position, the cartridge having a wire spool wound with a wire; an air guide disposed on a wire supply path and including a first inlet guide tube through which the wire drawn out from an outlet guide tube of the cartridge is drawn in, wherein the first inlet guide tube and the outlet guide tube are aligned on the wire supply path; a sensor disposed at the first inlet guide tube of the air guide, wherein the first inlet guide tube is configured to contact the outlet guide tube; and a first vacuum line generating a vacuum in the first inlet guide tube according to a detection of the wire by the sensor.

According to example embodiments, a wire feeder includes a cartridge disposed at a supply position and having a wire spool wound with a wire and an outlet guide tube through which the wire is drawn outwardly along an internal travel path; an air guide disposed on a wire supply path, and including a first inlet guide tube into which the wire drawn out from the outlet guide tube is drawn in and a first outlet guide tube through which the wire drawn inwardly from the first inlet guide tube is drawn out, wherein the first inlet guide tube and the outlet guide tube are aligned on the wire supply path; a sensor detecting the wire drawn into the first inlet guide tube of the air guide; a wire tension member disposed on the wire supply path, and including a second inlet guide tube into which the wire drawn out from the air guide is drawn in and a second outlet guide tube from which the wire is drawn out; and a plurality of vacuum lines sequentially generating vacuum inside the first inlet guide tube, the first outlet guide tube, the second inlet guide tube and the second outlet guide tube when the wire being introduced into the first inlet guide tube is detected by the sensor.

According to an example embodiment, a method of operating a wire feeder may include providing a cartridge at a supply position and having a wire spool wound with a wire; advancing the wire along an internal travel path of the cartridge and through an outlet guide tube of the cartridge; advancing the wire from the outlet guide tube along a wire supply path to a first inlet guide tube of an air guide, wherein the outlet guide tube is aligned with the first inlet guide tube; detecting, by a sensor, the wire at the first inlet guide tube of the air guide; applying a vacuum to an interior of the first inlet guide tube using a first vacuum line, upon detecting the wire at the first inlet guide tube of the air guide; and drawing the wire into the first inlet guide tube of the air guide using the vacuum applied by the first vacuum line.

According to an example embodiment, a method of operating a wire feeder may further include applying a vacuum to an interior of a first outlet guide tube of the air guide using a second vacuum line; and drawing the wire into the first outlet guide tube of the air guide using the vacuum applied by the second vacuum line.

According to an example embodiment, a method of operating a wire feeder may further include providing a wire tension member disposed on the wire supply path and including a second inlet guide tube into which the wire drawn from the air guide is introduced from the first outlet guide tube of the air guide; applying a vacuum to an interior of a second inlet guide tube of the wire tension member using a third vacuum line; drawing the wire into the second inlet guide tube of the wire tension member using the vacuum applied by the third vacuum line; applying a vacuum to an interior of a second outlet guide tube of the wire tension member using a fourth vacuum line; and drawing the wire into the second outlet guide tube of the wire tension member using the vacuum applied by the fourth vacuum line.

According to an example embodiment, a method of operating a wire feeder may further include advancing the wire from the wire tension member and through a clamp disposed on the wire supply path; and advancing the wire from clamp and through a capillary disposed on the wire supply path.

According to an example embodiment, a method of operating a wire feeder may further include advancing the wire from the capillary and to a semiconductor package; bonding the wire to the semiconductor package; and cutting the wire.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is an example drawing illustrating a wire feeder according to an example embodiment;

FIG. 2 is an example drawing illustrating a cartridge of a wire feeder according to an example embodiment;

FIG. 3 is an example drawing illustrating a shape of an outlet portion of a wire feeder and a first inlet portion of an air guide according to an example embodiment;

FIG. 4 is an example drawing illustrating a shape in which a wire is inserted into an outlet portion of a wire feeder and a first inlet portion of an air guide according to an example embodiment;

FIG. 5 is an example drawing illustrating another shape of an outlet portion of a wire feeder and a first inlet portion of an air guide in a wire feeder according to an example embodiment;

FIG. 6 is an example drawing illustrating a wire feeder according to another example embodiment; and

FIG. 7 is a flow diagram of a method of operating a wire feeder according to another example embodiment.

### DETAILED DESCRIPTION

Hereinafter, example embodiments will be described with reference to the accompanying drawings. Embodiments are described in sufficient detail to enable those skilled in the art to practice the invention. It is to be understood that various embodiments of the invention, although different, are not necessarily mutually exclusive. For example, a certain feature, structure, or characteristic described herein in connection with an embodiment may be implemented within other embodiments without departing from the spirit and scope of the invention. In addition, it is to be understood that the location or arrangement of individual elements within each embodiment may be modified without departing from the spirit and scope of the invention. The following detailed description is, therefore, not to be taken in a limiting sense, and the scope of the present inventive concept is defined only by the appended claims, appropriately interpreted, along with the full range of equivalents to which the claims are entitled. In the drawings, like numerals refer to the same or similar elements or functionality throughout the several views.

In a conventional wire feeder, when replacing a wire spool, wire from the wire spool must be manually worked through the wire feeder using a tool, such as tweezers, to pass the wire from the wire spool through various components of the wire feeder. According to an embodiment, a wire feeder may include a replaceable cartridge and at least one vacuum line for automatically advancing a wire drawn from the cartridge along a wire supply path. For example, the at least one vacuum line may be used to more smoothly and easily introduce the wire drawn out from the cartridge into a component of the wire feeder along the wire supply path. For example, a wire feeder may include a cartridge disposed in a supply position and having a wire spool wound with a wire, and including an outlet portion through which the wire may be drawn outwardly along an internal travel path, an air guide disposed on a wire supply path and including a first inlet portion through which the wire drawn out from the outlet portion may be drawn into the air guide, a sensor disposed at the first inlet portion of the air guide in which the outlet portion is aligned with the first inlet portion, on the wire supply path, and a first vacuum line generating a vacuum in an interior of the first inlet portion according to a detection of the wire at the first inlet by the sensor.

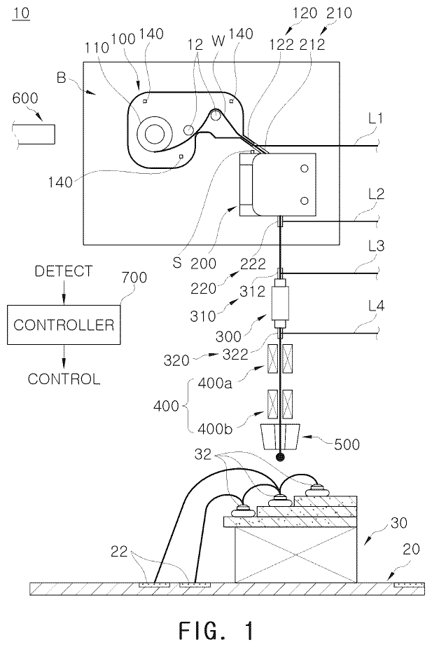

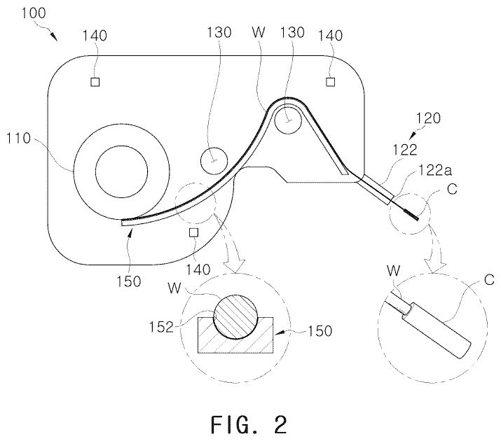

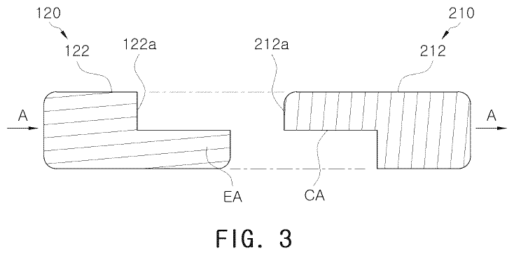

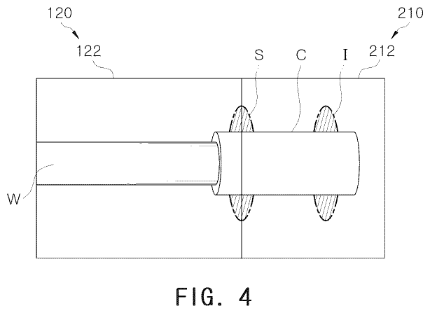

FIG. 1 is an example drawing illustrating a wire feeder according to an embodiment of the present inventive concept. FIG. 2 is an example drawing illustrating a cartridge of the wire feeder of FIG. 1. FIG. 3 is an example drawing illustrating the shapes of an outlet portion and a first inlet portion of an air guide of the wire feeder of FIG. 1. FIG. 4 is an example drawing illustrating the form of a wire inserted into the outlet portion and the first inlet portion of the air guide of the wire feeder of FIG. 1.

Referring to FIGS. 1 to 4, a wire feeder 10 according to an embodiment of the present inventive concept may include a cartridge 100, an air guide 200, a first vacuum line L1 and a sensor (S) disposed on a main body (B). The wire feeder 10 may further include a controller 700.

The cartridge 100 may include a wire spool 110, which may be wound with a wire (W), and an outlet portion 120 through which the wire (W) is drawn out along an internal movement path. The wire spool 110 may be connected to a drive motor that provides rotational force to the wire spool 110 by being connected to the wire spool 110 so that the wire (W) may be unwound. This drive motor may be disposed on the main body (B) of the wire feeder 10.

The wire feeder 10 may further include a mounting part, such as a mounting hole 130 and a connecting member 140. For example, the cartridge 100 may further include the mounting hole 130 and the connecting member 140 and the main body may include a diverter 12. The diverter 12 may be disposed on the main body (B) of the wire feeder 10 may be inserted and mounted in the mounting hole 130 to support the cartridge 100. For example, the cartridge 100 may be supported on the main body (B) through a structure in which the diverter 12 is inserted and mounted in the mounting hole 130. In another example, the diverter 12 and the mounting hole 130 may be reversed, and the diverter 12 may disposed on the cartridge 100 and may be inserted and mounted in the mounting hole 130 of the main body (B) of the wire feeder 10 to support the cartridge 100. The connecting member 140 may limit the position of the cartridge 100 on the main body (B) of the wire feeder 10 and may be implemented in various connecting structures. In an example embodiment, the connecting member 140 may be configured as at least one magnet disposed on at least one of the cartridge 100 or the main body (B). The cartridge 100 may be mounted on the main body (B) and limited in position by the magnet. However, the mounting part in the present inventive concept is not limited thereto. For example, the cartridge 100 may be implemented in a form using various methods such as an adhesive method or as a plurality of resilient clips formed on the main body (B) and configured to secure a position of the cartridge 100. For example, the cartridge 100 may be removed from the main body (B), where the resilient clips may be deformed to release the cartridge 100 by a pulling the cartridge 100 away from the main body (B).

In this case, the diverter 12 illustrated in FIG. 1 is illustrated as a form that functions to support the cartridge 100, but the present inventive concept is not limited thereto, and the diverter 12 may also be implemented in a form that functions to change the direction of the wire inside the cartridge 100.

In addition, as illustrated in FIG. 2 in an example embodiment, the cartridge 100 may further include a guide support member 150. The guide support member 150 may be disposed inside the cartridge 100 and may support the wire (W). The guide support member 150 may define an internal movement path inside the cartridge 100. The guide support member 150 may be formed in the form of a support plate whose end portion may be disposed adjacent to the wire spool 110 and extends toward the outlet portion 120. The wire (W) wound around the wire spool 110 may be supported on the upper surface 152 of the guide support member 150 and may be drawn out toward the outlet portion 120. The upper surface 152 of the guide support member 150 may be formed with a curved groove which may correspond to the shape of the wire (W) as illustrated in FIG. 2. For example, the curved surface of the groove formed on the upper surface 152 of the guide support member 150 may have a size set to be approximately the same as the diameter of the wire (W), but is not limited thereto. The wire (W) may be guided to a fixed position along the internal movement path formed by the upper surface 152 of the guide support member 150 and may be drawn out toward the outlet portion 120.

In the present inventive concept, the cartridge 100 has been described as having an internal movement path define by the guide support member 150, but is not limited thereto, and may be the internal movement path may be formed in the form of a tube or hole defining an internal movement path inside the cartridge, or the internal movement path may be limited by the diverter.

When the wire (W) on the wire spool 110 inside the cartridge 100 is consumed, the cartridge 100 may be replaced with a new cartridge 100. The replacement of the cartridge 100 may be performed manually or automatically. In an example embodiment, to automatically replace the cartridge 100, the wire feeder 10 may include a transfer arm 600 transferring the cartridge 100 to a supply position. When the wire (W) on the wire spool 110 is consumed and replacement of the cartridge 100 is to be performed, an operation of removing the cartridge 100 mounted on the main body (B) by the transfer arm 600 and an operation of transferring a new cartridge 100 to the supply position may be performed. However, the present inventive concept is not limited thereto. The cartridge replacement operation may be performed by an operator. Meanwhile, whether the wire (W) has been consumed may be confirmed in various ways. For example, when the wire (W) is consumed, the replacement time of the cartridge 100 may be confirmed by detecting a detection part of the wire (W) finally unwound from the wire spool 110 by a separate sensor disposed inside the cartridge 100 or air guide 200, but is not limited thereto. For example, an end portion of the wire (W) may be colored or coated with a coating material, and the separate sensor may detect a change in the wire (W) at the end portion corresponding to the color or coating material.

In an example embodiment, the wire (W) provided on the wire spool 110 may be formed of various materials. For example, the wire (W) may be formed of materials such as gold, silver, copper, gold-coated silver, palladium-coated copper, or palladium alloy-coated copper. As illustrated in FIG. 2, an end portion of the wire (W) may be coated with a coating layer (C) having a strength higher than the strength of the wire (W). In an example embodiment, when the wire (W) is formed of a gold material, palladium may be coated as a coating material on the end portion of the wire (W) to form a coating layer (C) coated on the end portion of the wire (W). Accordingly, the insertion of the wire (W) into the air guide 200 of the wire feeder 10, the wire tension member 300 described herein, the clamp 400, and the capillary 500 may be made through the structure in which a high-strength coating layer (C) is coated on the end portion of the wire (W). For example, the coating layer (C) may reduce friction between the wire (W) and components of the wire feeder 10, improve flexibility of the wire (W), or reduce static electricity, which may be beneficial when inserting the wire (W) and components of the wire feeder 10. When the insertion of the wire (W) into the capillary 500 is completed, the end portion of the wire (W) may be cut by the clamp 400, and a bonding operation may be performed.

The air guide 200 may be disposed on the wire supply path. The air guide 200 may be disposed adjacent to the cartridge 100 on the wire supply path. The air guide 200 may include a first inlet portion 210 into which a wire (W) drawn from the outlet portion 120 of the cartridge 100 may be drawn, and a first outlet portion 220 into which a wire (W) passing through the inside of the air guide 200 may be drawn. The air guide 200 may provide air into the inside to guide the wire (W) drawn from the first inlet portion 210 to the first outlet portion 220. The air guide 200 may provide an air stream into the inside to guide the wire (W) drawn from the first inlet portion 210 to the first outlet portion 220. For example, by controlling air pressure, velocity, and direction, the air stream may guide the wire (W) with reduced physical contact, which may improve efficiency and reduce material wear or damage.

In an example embodiment, the wire (W) may be inserted into the air guide 200 using the outlet portion 120 and the first inlet portion 210 of the cartridge 100. The outlet portion 120 may include an outlet guide tube 122, and the first inlet portion 210 of the air guide 200 may include a first inlet guide tube 212. The outlet guide tube 122 and the first inlet guide tube 212 may serve to guide the wire (W) drawn from the outlet portion 120 of the cartridge 100 to be drawn into the air guide 200 along the wire supply path to an aligned position. The extension direction of the outlet guide tube 122 and the extension direction of the first inlet guide tube 212 may be the same. For example, the extension direction of the outlet guide tube 122 and the extension direction of the first inlet guide tube 212 may be aligned in the same direction. As an example, as illustrated in FIG. 1, the outlet guide tube 122 and the first inlet guide tube 212 may be formed in various forms.

In an example embodiment, the outlet guide tube 122 of the cartridge 100 and the first inlet guide tube 212 of the air guide 200 may come into contact with each other with the cartridge 100 disposed at the supply position. In this case, the supply position of the cartridge 100 may be the position in which the outlet portion 120 is aligned with the first inlet portion 210 of the air guide 200, and specifically, the supply position of the cartridge 100 may be the position in which the outlet portion 120 of the cartridge 100 is aligned with the first inlet portion 210 of the air guide 200 enabling the wire (W) on the wire spool 110 to be consumed. The outlet guide tube 122 of the cartridge 100 and the first inlet guide tube 212 of the air guide 200 may be disposed in various directions, and for example, may be disposed to be aligned in an arbitrary inclined direction between the vertical direction and the horizontal direction.

The outlet guide tube 122 of the cartridge 100 and the first inlet guide tube 212 of the air guide 200 may have a structure in which a portion overlaps the wire supply path. For example, as illustrated in FIG. 1 and FIG. 3, a cutaway area (CA) formed at the inlet end portion 212a of the first inlet guide tube 212. FIG. 3 is an exploded view of the cutaway area (CA) formed by the outlet portion 120 of the cartridge 100 and the first inlet portion 210 of the air guide 200. An extension area (EA) formed in a shape corresponding to the cutaway area (CA) may be formed at the outlet end portion 122a of the outlet guide tube 122. With the cartridge 100 disposed at the supply position, the extension area (EA) formed at the outlet end portion 122a of the outlet guide tube 122 may be positioned at the cutaway area (CA) formed at the inlet end portion 212a of the first inlet guide tube 212, and the outlet guide tube 122 of the cartridge 100 and the first inlet guide tube 212 of the air guide 200 may at least partially overlap on the wire supply path A. Through this structure, the wire (W) drawn out from the outlet portion 120 of the cartridge 100 may be introduced into the air guide 200 at the aligned position along the wire supply path A.

The sensor (S) may detect the wire (W) being drawn into the first inlet portion 210 of the air guide 200 of the cartridge 100 where the outlet portion 120 of the cartridge 100 is aligned with the first inlet portion 210 of the air guide 200 on the wire supply path. The sensor (S) may be disposed on the air guide 200 adjacent to the first inlet guide tube 212. The sensor (S) may be implemented any of various sensors. In an example embodiment, the sensor (S) may be a photo sensor. The sensor (S) may irradiate light toward an overlapping portion of the outlet guide tube 122 and the first inlet guide tube 212, as illustrated in FIG. 4. At least one of the outlet guide tube 122 or the first inlet guide tube 212 may be formed of a light transmissive material and the sensor (S) may detect the wire (W) located in the cutaway area (CA) through the light transmissive material. For example, the sensor (S) may detect the wire (W) located in the cutaway area (CA) by irradiating light toward the cutaway area (CA) of the first inlet guide tube 212. In another example, the overlapping portion may not form a complete overlap, and the sensor (S) may detect the wire (W) located in the cutaway area (CA) in a space between the outlet guide tube 122 or the first inlet guide tube 212. The sensor (S) may transmit a signal (DETECT) to the controller 700, the signal indicating the wire (W) is located in the cutaway area (CA).

The first vacuum line L1 may generate a vacuum inside the first inlet portion 210 of the air guide 200. The first vacuum line L1 may be connected to a vacuum generating device such as a vacuum pump and may provide a suction force to draw the wire (W) so that the wire (W) may be automatically inserted into the air guide 200. For example, the controller 700, having received the signal (DETECT) of the sensor (S) indicating the wire (W) is located in the cutaway area (CA) may operate the vacuum generating device to provide the suction force. For example, the controller 700 may generating a control signal (CONTROL) to operate the vacuum generating device. The first vacuum line L1 may generate a vacuum inside the first inlet portion 210 when the wire (W) is detected to be drawn into the first inlet portion 210 of the air guide 200 by the sensor (S). In an example embodiment, the suction port (I) of the first vacuum line L1 may be disposed inside the first inlet guide tube 212. The suction port (I) of the first vacuum line L1 may be disposed so as not to overlap with the wire supply path so as not to cause interference with the wire supply path inside the first inlet guide tube 212. For example, as illustrated in FIG. 4, the suction port (I) of the first vacuum line L1 may be disposed laterally inside the first inlet guide tube 212 adjacent to the wire supply path. The suction port (I) of the first vacuum line L1 may be disposed diagonally inside the first inlet guide tube 212. The suction port (I) of the first vacuum line L1 may be disposed so as to face the inlet end portion 212a of the first inlet guide tube 212. Accordingly, when the wire (W) introduced into the first inlet guide tube 212 of the first inlet portion 210 is detected by the sensor (S), a vacuum may be generated inside the first inlet guide tube 212 through the first vacuum line L1.

According to an example configuration, when the wire (W) on the wire spool 110 (e.g., a previous spool) is exhausted and the cartridge 100 is replaced, the cartridge 100 (e.g., a new cartridge) may be mounted on the main body (B) at the supply position, and the outlet guide tube 122 of the outlet portion 120 of the cartridge 100 may be aligned with and in contact with the first inlet guide tube 212 of the first inlet portion 210 of the air guide 200, and the wire (W) on the wire spool 110 of the cartridge 100 may be released. When the end portion of the wire (W) passes through the outlet guide tube 122 and the first inlet guide tube 212 is drawn in, the wire (W) may be detected by the sensor (S). At this time, the first vacuum line L1 may generate a vacuum inside the first inlet guide tube 212 to provide a suction force, so that the wire (W) may be automatically inserted into the air guide 200.

In addition, the first outlet portion 220 of the air guide 200 may include a first outlet guide tube 222. The first outlet guide tube 222 may guide the wire (W) from the inside of the air guide 200 to be drawn out.

The wire feeder 10 may further include a second vacuum line L2 that may generate a vacuum inside the first outlet portion 220. The second vacuum line L2 may be connected to a vacuum generating device such as a vacuum pump, and may generate a vacuum inside the first outlet guide tube 222 to provide a suction force for drawing the wire (W) so that the wire (W) passing through the inside of the air guide 200 may be drawn out through the first outlet guide tube 222. The suction port of the second vacuum line L2 may be disposed inside the first outlet guide tube 222. The suction port of the second vacuum line L2 may be disposed so as not to overlap with the wire supply path so as not to interfere with the wire supply path inside the first outlet guide tube 222. For example, the suction port of the second vacuum line L2 may be disposed adjacent to the wire supply path inside the first outlet guide tube 222. For example, the suction port of the second vacuum line L2 may be disposed diagonally so as not to overlap with the wire supply path inside the first outlet guide tube 222.

Meanwhile, the wire feeder 10 may further include a wire tension member 300, a third vacuum line L3, and a fourth vacuum line L4. The wire tension member 300 may be disposed on the wire supply path and may adjust the tension of the wire (W) drawn from the air guide 200. In an example embodiment, the wire tension member 300 may adjust the tension of the wire (W) using a vacuum force. The wire tension member 300 may include a second inlet portion 310 into which a wire (W) drawn from an air guide 200 may be drawn and a second outlet portion 320 through which the wire (W) may be drawn. In an example embodiment, the second inlet portion 310 may include a second inlet guide tube 312, and the second outlet portion 320 may include a second outlet guide tube 322. The third vacuum line L3 may generate a vacuum inside the second inlet portion 310 of the wire tension member 300. In an example embodiment, the suction port of the third vacuum line L3 may be disposed inside the second inlet guide tube 312. The suction port of the third vacuum line L3 may be disposed so as not to overlap the wire supply path so as not to cause interference with the wire supply path inside the second inlet guide tube 312. For example, the suction port of the third vacuum line L3 may be disposed adjacent to the wire supply path inside the second inlet guide tube 312. For example, the suction port of the third vacuum line L3 may be disposed diagonally so as not to overlap with the wire supply path inside the second inlet guide tube 312. The suction port of the third vacuum line L3 may be disposed so as to face the inlet end portion of the second inlet guide tube 312 (the end portion of the second inlet guide tube 312 adjacent to the air guide). The fourth vacuum line LA may generate a vacuum inside the second outlet portion 320 of the wire tension member 300. The fourth vacuum line L4 may be connected to a vacuum generating device such as a vacuum pump and may generate a vacuum inside the second outlet guide tube 322 so that the wire (W) passing through the inside of the wire tension member 300 may be drawn out through the second outlet guide tube 322, thereby providing a suction force for drawing the wire (W). The suction port of the fourth vacuum line LA may be disposed inside the second outlet guide tube 322. The suction port of the fourth vacuum line L4 may be disposed so as not to overlap with the wire supply path so as not to cause interference with the wire supply path inside the second outlet guide tube 322. For example, the suction port of the fourth vacuum line L4 may be disposed adjacent to the wire supply path inside the second outlet guide tube 322. For example, the suction port of the fourth vacuum line L4 may be disposed diagonally so as not to overlap with the wire supply path inside the second outlet guide tube 322.

In an example embodiment, two or more of the first vacuum line L1, the second vacuum line L2, the third vacuum line L3, or the fourth vacuum line L4 may operate sequentially. The first vacuum line L1, the second vacuum line L2, the third vacuum line L3, and the fourth vacuum line L4 may be connected to a vacuum generating device and operated sequentially by an on-off valve. For example, the on-off valve may be operated by the controller 700 using the control signal (CONTROL). However, the present inventive concept is not limited thereto, and the first vacuum line L1, the second vacuum line L2, the third vacuum line L3, and the fourth vacuum line L4 may respectively be independently connected to a vacuum generating device. For example, the vacuum generating device may be operated by the controller 700 using the control signal (CONTROL). When the cartridge 100 is disposed at the supply position, the wire (W) to be drawn into the first inlet portion 210 of the air guide 200 may be detected by the sensor (S), and the first vacuum line L1, the second vacuum line L2, the third vacuum line L3, and the fourth vacuum line L4 may operate sequentially, so that the wire (W) drawn from the outlet portion 120 of the cartridge 100 may automatically and sequentially pass through the air guide 200 and the wire tension member 300, enabling insertion of the wire (W) when mounting the cartridge 100 equipped with the wire spool 110.

Meanwhile, the wire feeder 10 may further include a clamp 400 and a capillary 500. The clamp 400 may clamp the wire (W) drawn from the wire tension member 300. The capillary 500 may be fed with the wire (W) through the clamp 400. The capillary 500 may guide the wire (W) by reciprocating between the lead 22 of the substrate 20 and the pad 32 of the semiconductor chip 30. Through this, the wire (W) may electrically connect the lead 22 of the substrate 20 and the pad 32 of the semiconductor chip 30. The clamp 400 may control the supply of the wire (W) to the capillary 500 by clamping or releasing the clamping of the wire (W). The clamp 400 may be provided as a plurality of clamps. In an example embodiment, FIG. 1 illustrates two clamps, wherein a first clamp 400a on the upper side may hold a wire (W) at a certain height and perform an operation of clamping or unclamping the wire (W), and a second clamp 400b on the lower side may perform an operation of clamping or unclamping the wire (W) and may move up and down simultaneously with the capillary 500 by a moving member. By the operations of the first clamp 400a, the second clamp 400b and the capillary 500, the wire (W) may be supplied to the lead 22 of the substrate 20 and the pad 32 of the semiconductor chip 30 to be bonded, thereby electrically connecting the substrate 20 and the semiconductor chip 30. However, the present inventive concept is not limited to example embodiments in which the clamp 400 is composed of two clamps, and the clamp 400 may be composed of one or three or more clamps.

Accordingly, when the wire (W) introduced into the first inlet portion 210 of the air guide 200 at the supply location of the cartridge 100 is detected by the sensor (S), the first vacuum line L1, the second vacuum line L2, the third vacuum line L3, and the fourth vacuum line L4 may be sequentially operated so that the wire (W) passes through the wire tension member 300 and may be automatically supplied to the clamp 400 and the capillary 500, thereby implementing efficient insertion of the wire (W), and the bonding work of the lead 22 of the substrate 20 and the pad 32 of the semiconductor chip 30 may be performed by the operation of the clamp 400 and the capillary 500.

In some embodiments, a photo sensor has been described as a sensor, but the present inventive concept is not limited thereto, and various sensors may be applied. The sensor may be configured to detect the presence or absence of a wire introduced into the first inlet portion of the air guide by any of various methods. For example, a contact sensor detecting a wire by contact with the wire may be applied.

In addition, the configuration of the wire tension member 300 has been described as a form in which the second inlet portion 310 includes a second inlet guide tube 312 and the second outlet portion 320 includes a second outlet guide tube 322, but the present inventive concept is not limited thereto. For example, the wire tension member may be implemented in a form in which the second inlet portion includes a second inlet guide tube and the second outlet portion does not include a second outlet guide tube, or in a form in which the second inlet portion does not include a second inlet guide tube and the second outlet portion includes a second outlet guide tube, or in a form in which the second inlet portion does not include a second inlet guide tube and the second outlet portion does not include a second outlet guide tube, and in this case, the third vacuum line or the fourth vacuum line may be omitted.

According to an embodiment, the overlapping structure of the first inlet portion 210 of the air guide 200 and the outlet portion 120 of the cartridge 100 is described as having a cutaway area (CA) formed at the inlet end portion 212a of the first inlet guide tube 212 and an extension area (EA) formed having a dimension corresponding to the cutaway area (CA) formed at the outlet end portion 122a of the outlet guide tube 122. For example, a depth of the cutaway area (CA) may correspond to about 50% of a width (or diameter) of the first inlet guide tube 212 and a width of the extension area (EA) may correspond to about 50% of a width (or diameter) of the outlet guide tube 122. However, the present inventive concept is not limited thereto and may be implemented in various forms. For example, a depth of the cutaway area (CA) may correspond to about 75% of a width (or diameter) of the first inlet guide tube 212 and a width of the extension area (EA) may correspond to about 75% of a width (or diameter) of the outlet guide tube 122. According to an embodiment, the overlapping structure of the first inlet portion 210 of the air guide 200 and the outlet portion 120 of the cartridge 100 is described as having a cutaway area (CA) formed at the inlet end portion 212a of the first inlet guide tube 212 and an extension area (EA) formed in a shape corresponding to the cutaway area (CA) formed at the outlet end portion 122a of the outlet guide tube 122. However, the present inventive concept is not limited thereto and may be implemented in various forms.

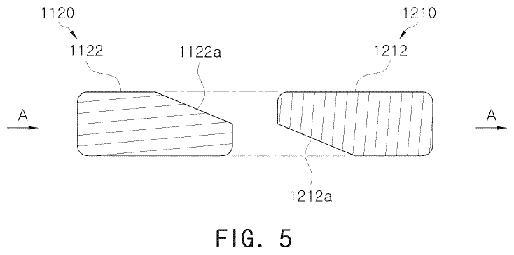

FIG. 5 is an example drawing illustrating a form of the outlet portion and the first inlet portion of the air guide according to an example embodiment.

Referring to FIG. 5, the wire feeder according to an embodiment of the present inventive concept may include a cartridge, an air guide, a wire tension member, a sensor, a clamp, a capillary, a first vacuum line, a second vacuum line, a third vacuum line, and a fourth vacuum line. The configuration of the cartridge, the air guide, the wire tension member, the sensor, the clamp, the capillary, the first vacuum line, the second vacuum line, the third vacuum line, and the fourth vacuum line may be implemented in the same manner as the cartridge 100, the air guide 200, the wire tension member 300, the sensor (S), the clamp 400, the capillary 500, the first vacuum line L1, the second vacuum line L2, the third vacuum line L3, and the fourth vacuum line L4 described in connection with FIG. 1, and thus, a duplicate description thereof may be omitted or simplified.

Referring to FIG. 5, the outlet guide tube 1122 of the outlet portion 1120 of the cartridge and the first inlet guide tube 1212 of the first inlet portion 1210 of the air guide may have a structure in which at least a portion overlaps on the wire supply path A. For example, a first overlapping surface 1212a may be formed at the inlet end portion of the first inlet guide tube 1212, a portion of which may be cut diagonally. A second overlapping surface 1122a may be formed at the outlet end portion of the outlet guide tube 1122, a portion of which may be cut diagonally and may have a shape corresponding to the first overlapping surface 1212a. With the cartridge 100 disposed at the supply position, the second overlapping surface 1122a formed at the outlet end portion of the outlet guide tube 1122 may be positioned at the first overlapping surface 1212a formed at the inlet end portion of the first inlet guide tube 1212 and may come into contact with each other, so that the outlet guide tube 1122 of the cartridge and the first inlet guide tube 1212 of the air guide may overlap on the wire supply path A. Through this structure, the wire drawn from the outlet portion 1120 of the cartridge may be drawn into the air guide along the wire supply path into the aligned position. In this case, the sensor (S) may detect the wire (W) drawn into the first inlet portion 1210 of the air guide 200, where the outlet portion 1120 of the cartridge 100 disposed at the supply position is aligned with the first inlet portion 1210 of the air guide 200 on the wire supply path.

In addition, the outlet portion of the cartridge and the first inlet portion of the air guide are described as being disposed in an inclined manner, but the present inventive concept is not limited thereto, and may be variously changed depending on a specific structure of the wire feeder used in the actual bonding process.

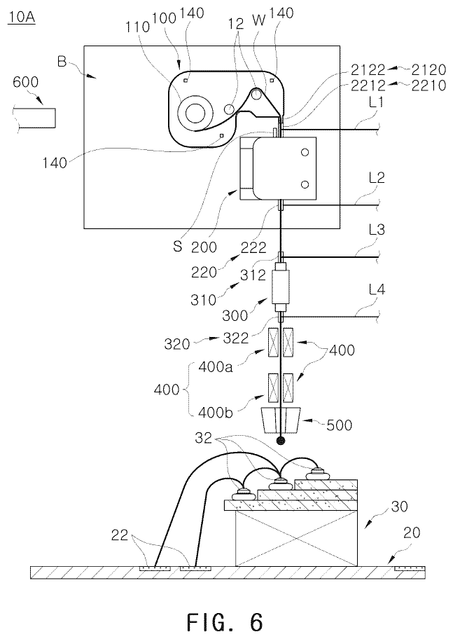

FIG. 6 is an example drawing illustrating a wire feeder according to an embodiment of the present inventive concept.

A wire feeder 10A according to an embodiment of the present inventive concept may include a cartridge 100, an air guide 200, a wire tension member 300, a sensor (S), a clamp 400, a capillary 500, a first vacuum line L1, a second vacuum line L2, a third vacuum line L3, and a fourth vacuum line L4. The configuration of the cartridge 100, the air guide 200, the wire tension member 300, the sensor (S), the clamp 400, the capillary 500, the first vacuum line L1, the second vacuum line L2, the third vacuum line L3, and the fourth vacuum line L4 may be implemented in the same manner as the cartridge 100, the air guide 200, the wire tension member 300, the sensor (S), the clamp 400, the capillary 500, the first vacuum line L1, the second vacuum line L2, the third vacuum line L3, and the fourth vacuum line L4 described in connection with FIG. 1, and thus, a duplicate description thereof may be omitted or simplified.

The outlet portion 2120 of the cartridge 100 may include an outlet guide tube 2122, and the first inlet portion 2210 of the air guide 200 may include a first inlet guide tube 2212. The outlet guide tube 2122 and the first inlet guide tube 2212 may guide a wire (W) drawn out from the outlet portion 2120 of the cartridge 100 to be drawn into the air guide 200 at an aligned position along the wire supply path. The extension direction of the outlet guide tube 2122 and the extension direction of the first inlet guide tube 2212 may be the same. For example, the extension direction of the outlet guide tube 2122 and the extension direction of the first inlet guide tube 2212 may be aligned in the same direction. As illustrated in FIG. 6, the outlet portion 2120 of the cartridge 100 may be disposed on the lower end portion of the cartridge 100, and the outlet guide tube 2122 of the outlet portion 2120 may extend in a vertical direction. For example, an input direction of the air guide 200 may be aligned to an output direction of the air guide 200. Further, in an example, the input direction and the output direction may be aligned with the wire supply path through the wire tension member 300, the clamp 400, and the capillary 500. The first inlet portion 2210 of the air guide 200 may be disposed on the upper end portion of the air guide 200, and the first inlet guide tube 2212 of the first inlet portion 2210 may extend in the vertical direction. With the cartridge 100 disposed at the supply position, the outlet guide tube 2122 of the cartridge 100 and the first inlet guide tube 2212 of the air guide 200 may be in contact with each other and aligned in a straight line in the vertical direction. Furthermore, the first outlet portion 220 of the air guide 200 may be disposed on the lower end portion of the air guide 200, and the first outlet guide tube 222 of the first outlet portion 220 may be disposed in a straight line with the first inlet guide tube 2212 in the vertical direction. Furthermore, the wire tension member 300, the clamp 400, and the capillary 500 may be disposed in a straight line in the vertical direction. Accordingly, the wire (W) drawn out from the outlet portion 2120 of the cartridge 100 may be inserted into the air guide 200, the wire tension member 300, the clamp 400, and the capillary 500 sequentially along the vertical direction.

As set forth herein, according to an example embodiment, a wire feeder in which efficient insertion may be implemented when replacing a cartridge disposed inside a wire spool may be provided.

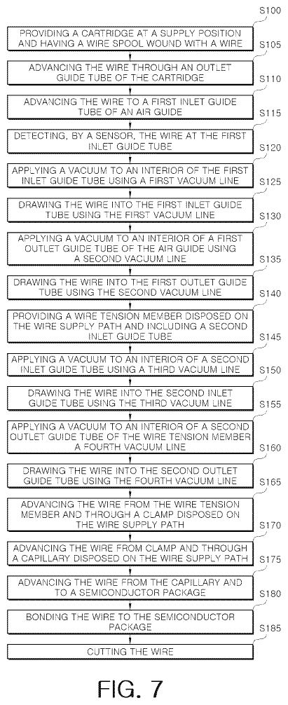

As set forth herein and referring to FIG. 7, according to an example embodiment, a method of operating a wire feeder may include providing a cartridge at a supply position and having a wire spool wound with a wire (S100), advancing the wire along an internal travel path of the cartridge and through an outlet guide tube of the cartridge (S105), advancing the wire from the outlet guide tube along a wire supply path to a first inlet guide tube of an air guide, wherein the outlet guide tube is aligned with the first inlet guide tube (S110), detecting, by a sensor, the wire at the first inlet guide tube of the air guide (S115), applying a vacuum to an interior of the first inlet guide tube using a first vacuum line, upon detecting the wire at the first inlet guide tube of the air guide (S120), and drawing the wire into the first inlet guide tube of the air guide using the vacuum applied by the first vacuum line (S125).

According to an example embodiment, a method of operating a wire feeder may further include applying a vacuum to an interior of a first outlet guide tube of the air guide using a second vacuum line (S130), and drawing the wire into the first outlet guide tube of the air guide using the vacuum applied by the second vacuum line (S135).

According to an example embodiment, a method of operating a wire feeder may further include providing a wire tension member disposed on the wire supply path and including a second inlet guide tube into which the wire drawn from the air guide is introduced from the first outlet guide tube of the air guide (S140), applying a vacuum to an interior of a second inlet guide tube of the wire tension member using a third vacuum line (S145), drawing the wire into the second inlet guide tube of the wire tension member using the vacuum applied by the third vacuum line (S150), applying a vacuum to an interior of a second outlet guide tube of the wire tension member using a fourth vacuum line (S155), and drawing the wire into the second outlet guide tube of the wire tension member using the vacuum applied by the fourth vacuum line (S160).

According to an example embodiment, a method of operating a wire feeder may further include advancing the wire from the wire tension member and through a clamp disposed on the wire supply path (S165), and advancing the wire from clamp and through a capillary disposed on the wire supply path (S170).

According to an example embodiment, a method of operating a wire feeder may further include advancing the wire from the capillary and to a semiconductor package (S175), bonding the wire to the semiconductor package (S180), and cutting the wire (S185).

While example embodiments have been illustrated and described herein, it will be apparent to those skilled in the art that modifications and variations could be made without departing from the scope of the present inventive concept as defined by the appended claims.

What is claimed is:

1. A wire feeder comprising:
a cartridge disposed in a supply position and having a wire spool wound with a wire, and including an outlet portion through which the wire is drawn outwardly along an internal travel path;
an air guide disposed on a wire supply path and including a first inlet portion through which the wire drawn out from the outlet portion is drawn in, wherein the first inlet portion is aligned with the outlet portion on the wire supply path;
a sensor disposed at the first inlet portion of the air guide; and
a first vacuum line generating a vacuum in an interior of the first inlet portion according to a detection of the wire at the first inlet portion by the sensor.

2. The wire feeder of claim 1, wherein the first inlet portion includes a first inlet guide tube, and
the sensor is disposed adjacent to the first inlet guide tube on the air guide.

3. The wire feeder of claim 2, wherein a suction port of the first vacuum line is disposed inside the first inlet guide tube.

4. The wire feeder of claim 1, wherein the outlet portion includes an outlet guide tube through which the wire passes, and
the first inlet portion includes a first inlet guide tube contacting the outlet guide tube.

5. The wire feeder of claim 4, wherein the outlet guide tube and the first inlet guide tube have a structure of partially overlapping on the wire supply path.

6. The wire feeder of claim 5, wherein an inlet end portion of the first inlet guide tube includes a cutaway area,
an outlet end portion of the outlet guide tube includes an extension area having a form corresponding to the cutaway area and positioned in the cutaway area, and
the sensor is disposed adjacent to the first inlet guide tube on the air guide.

7. The wire feeder of claim 6, wherein the sensor is a photo sensor irradiating light toward the cutaway area.

8. The wire feeder of claim 4, wherein an extension direction of the outlet guide tube and an extension direction of the first inlet guide tube are the same.

9. The wire feeder of claim 4, wherein the air guide includes a first outlet guide tube through which the wire introduced into an inside of the air guide from the first inlet guide tube is drawn out from the air guide, and
the wire feeder further includes a second vacuum line generating a vacuum inside the first outlet guide tube.

10. The wire feeder of claim 1, wherein the cartridge includes:
a mounting hole in which a diverter disposed on a main body of the wire feeder is inserted; and
a connecting member securing a position of the cartridge to the main body of the wire feeder.

11. The wire feeder of claim 10, wherein the connecting member comprises at least one magnet disposed in the cartridge.

12. The wire feeder of claim 1, wherein the cartridge includes a guide support member supporting the wire internally and defining an internal movement path of the wire inside the cartridge.

13. The wire feeder of claim 1, wherein an end portion of the wire is coated with a coating layer.

14. The wire feeder of claim 1, further comprising:
a wire tension member disposed on the wire supply path and including a second inlet guide tube into which the wire drawn from the air guide is introduced; and
a third vacuum line generating a vacuum inside the second inlet guide tube.

15. The wire feeder of claim 14, wherein the wire tension member includes a second outlet guide tube through which the wire is drawn, and
the wire feeder includes a fourth vacuum line generating a vacuum inside the second outlet guide tube.

16. The wire feeder of claim 14, further comprising:
a clamp disposed adjacent to the wire tension member on the wire supply path; and
a capillary disposed adjacent to the clamp on the wire supply path.

17. A wire feeder comprising:
a main body including a mounting part configured to secure a cartridge in a supply position, the cartridge having a wire spool wound with a wire;
an air guide disposed on a wire supply path and including a first inlet guide tube through which the wire drawn out from an outlet guide tube of the cartridge is drawn in, wherein the first inlet guide tube and the outlet guide tube are aligned on the wire supply path;
a sensor disposed at the first inlet guide tube of the air guide, wherein the first inlet guide tube is configured to contact the outlet guide tube; and
a first vacuum line generating a vacuum in the first inlet guide tube according to a detection of the wire by the sensor.

18. The wire feeder of claim 17, wherein the outlet guide tube and the first inlet guide tube have a structure in which portions thereof overlap on the wire supply path,
an inlet end portion of the first inlet guide tube is provided with a cutaway area,
an outlet end portion of the outlet guide tube is provided with an extension area having a form corresponding to the cutaway area and positioned in the cutaway area, and
the sensor is a photo sensor disposed adjacent to the first inlet guide tube on the air guide and irradiating light toward the cutaway area.

19. The wire feeder of claim 17, further comprising a transfer arm transferring the cartridge to the supply position.

20. A wire feeder comprising:
a cartridge disposed at a supply position and having a wire spool wound with a wire and an outlet guide tube through which the wire is drawn outwardly along an internal travel path;
an air guide disposed on a wire supply path, and including a first inlet guide tube into which the wire drawn out from the outlet guide tube is drawn in, and a first outlet guide tube through which the wire drawn inwardly from the first inlet guide tube is drawn out, wherein the first inlet guide tube and the outlet guide tube are aligned on the wire supply path;
a sensor detecting the wire drawn into the first inlet guide tube of the air guide;
a wire tension member disposed on the wire supply path, and including a second inlet guide tube into which the wire drawn out from the air guide is drawn in and a second outlet guide tube from which the wire is drawn out; and
a plurality of vacuum lines sequentially generating vacuum inside the first inlet guide tube, the first outlet guide tube, the second inlet guide tube and the second outlet guide tube when the wire being introduced into the first inlet guide tube is detected by the sensor.
